(19) United States
(12) Patent Application Publication
(10) Pub. No.: US 2011/0192990 A1
(43) Pub. Date: Aug. 11, 2011

(54) Measuring device for the measurement of bioluminescence, chemoluminescence or fluorescence of objects, irradiation device, measuring system, and method for the observation of plants

(75) Inventor: Manfred HENNECKE, Remshalden (DE)

(73) Assignee: Berthold Technologies GmbH & Co. KG, Bad Wildbad (DE)

(21) Appl. No.: 12/796,259

(22) Filed: Jun. 8, 2010

(30) Foreign Application Priority Data
Feb. 5, 2010 (DE) 20 2010 002 010.7

(51) Int. Cl. G01J 1/58

(52) U.S. Cl. 250/458.1; 250/208.1

(57) ABSTRACT

Described is a measuring device for the measurement of bioluminescence, chemoluminescence or fluorescence of objects. The measuring device comprises a light-tight housing (10) enclosing a measuring chamber (K) and a highly sensitive camera (40) looking into the measuring chamber. Arranged in the measuring chamber (K) is a vertically extending rotary shaft (24) for the arrangement of a rotary disk (20) and, in a first state of operation, the line of vision of the camera (40) is substantially horizontal. This makes the measuring device suitable in particular for the observation of plants. Also described is an irradiation device that can be used in conjunction with such a measuring device, a system comprising a measuring device and an irradiation device, and methods for the observation of plants using such a measuring system.

The invention relates to a measuring device for the measurement of bioluminescence, chemoluminescence or fluorescence of objects according to the preamble of claim 1, an irradiation device according to claim 11, a measuring system according to claim 15, and a method for the observation of plants according to claim 19.

Methods for the measurement of fluorescence and luminescence have been used successfully in biological and pharmaceutical research for many years. These methods involve the use of transfected or transgenic animals or plants, at least one gene of the respective plant or respective animal being able to code a protein that exhibits luminescence or fluorescence. If this gene is active, this protein is formed and by observing the luminescence or fluorescence of this protein, one can draw conclusions regarding the activity of the respective gene and thus furthermore, for example, regarding the efficacy of certain substances on the plant/animal.

Existing devices for the performance of such a method are substantially designed as follows: they have a housing that encloses a measuring chamber in a light tight manner, the housing having a door through which the object to be measured can be placed into the measuring chamber. Mounted to the roof of the housing is a camera, the optical axis and line of vision of which extends perpendicularly, and which therefore looks down into the measuring chamber. As a rule, this camera has a very sensitive, cooled CCD sensor, such that the camera is able to generate images with position resolution from the generally very weak luminescence signals. If, in addition, a “normal” photographic image is to be taken of the animal or plant to be measured, an illumination means is provided in the region of the roof of the housing. This illumination means radiates from above, that is to say substantially parallel to the line of vision of the camera, which, when in a corresponding state of operation, can then also take photographic exposures. The fluorescence exposure and the photographic exposure (photographic exposure in this context refers to an exposure that is based on the reflection or absorption of light) can be superimposed one over another in a subsequent data processing step, such that one can very easily see from which area of the animal/plant the luminescence light originates. If fluorescence is to be measured instead of luminescence, a fluorescence excitation source with an excitation filter is provided in addition and it must be possible to place an emission filter into the optical path of the camera.

A measuring device like the one that has just been described is manufactured and sold, for example, by Berthold Technologies under the trade name “NightOWL”.

In US 2006/0057710 A1 there is shown a measuring device for measuring the bioluminescence of organic material. This measuring device is mechanically very complex and is not suitable for the measurement of whole plants.

Proceeding from this prior art, it is the aim of the present invention to improve a measuring device of the generic type in such a way that it is even better suited for the study of plants.

This aim is achieved by a measuring device having the features of claim 1.

According to the invention, the camera, in a first state of operation, looks into the measuring chamber not from above but from the side. This means that the line of vision of the camera does not extend substantially vertically, like in existing measuring devices of the generic type. Preferably, the line of vision extends horizontally, although certain deviations from this horizontal direction are possible.

Furthermore, a vertically extending rotary shaft for a rotary disk is arranged in a lower region of the housing. In this way it is possible for exposures (photographic exposures and luminescence or fluorescence exposures) to be taken from multiple sides of a plant, and also for a plurality of plants—in particular in special containers—to be arranged on the rotary disk, thereby enabling a plurality of plants to be observed during one measuring cycle. To achieve this effect, the rotary disk preferably has a plurality of holding devices.

On the one hand, the lateral line of vision of the camera permits an observation of the whole plant, including the roots, provided that the plant is being grown in a transparent gel that is located in a transparent container, and on the other hand the upper leaves of the plant do not obstruct the view of the plant parts located underneath.

According to claim 4, a downwardly radiating irradiation means is provided above the position of the rotary disk, such that plants that are to be studied can also grow within the measuring device. Because of these irradiation means the plant behaves naturally, that is to say it grows substantially vertically upward.

The camera used is preferably suitable for luminescence measurements, for which it preferably additionally has a cooled semiconductor sensor.

It is another aim of the invention to provide a system, with the help of which a large number of plants can be observed.

To achieve this effect, an irradiation device having the features of claim 11 is proposed, and a measuring system as claimed in claim 15.

A method for the observation of plants with the aid of such a measuring system is specified in claim 19.

In order to be able to arrive at a finding regarding the growth of plants, the plants must, as a rule, be observed over a period of several days. Measuring the luminescence or fluorescence, however, is necessary only once or twice a day in some cases, and at the most for a few minutes every hour. The plants to be observed do not necessarily need to be inside the measuring device with the expensive, highly sensitive camera during the remaining time, but they can be housed in a separate irradiation device during this time, in which they are stimulated to grow by means of controlled and therefore reproducible irradiation.

Preferred embodiments of the invention will become apparent from the additional subclaims and from the illustrative examples that will now be presented with reference to the figures, in which:

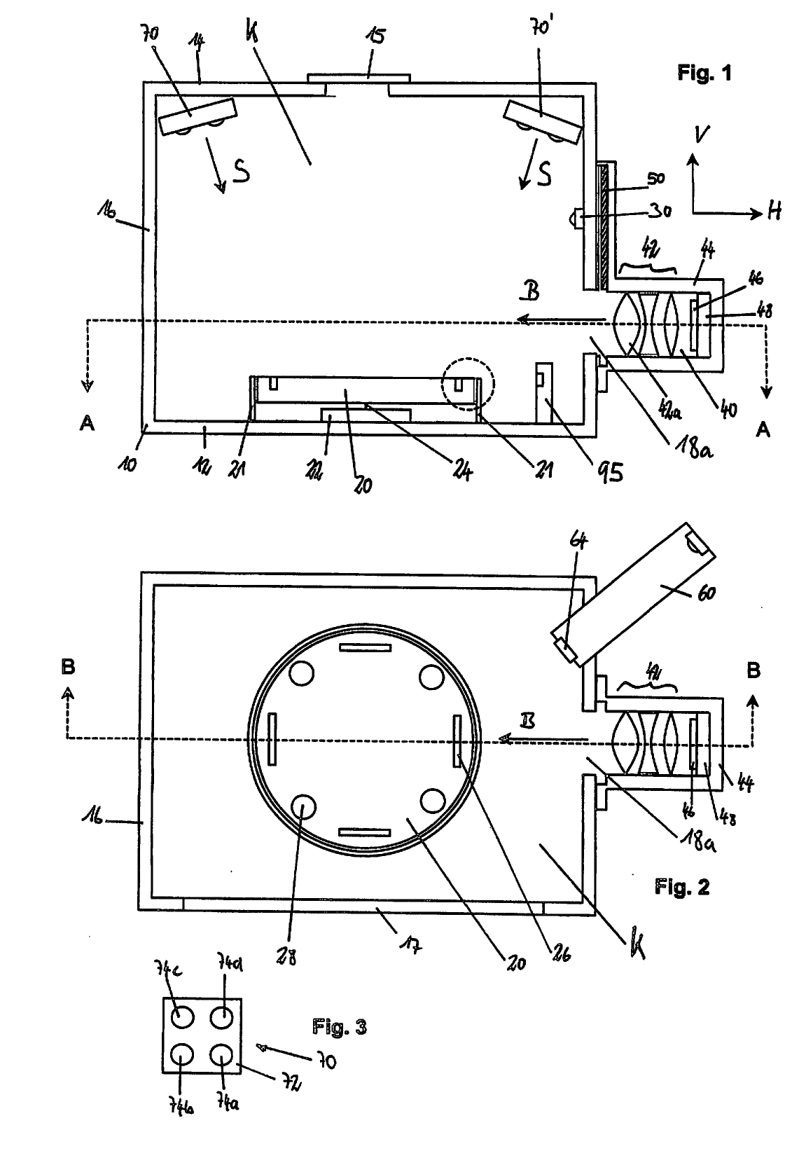

FIG. 1 shows, in a schematic sectional view, the sectional plane extending vertically, a measuring device in a first state of operation,

FIG. 1a shows the measuring device of FIG. 1 with an alternative arrangement of infrared diodes,

FIG. 2 shows a section along the plane A-A of FIG. 1,

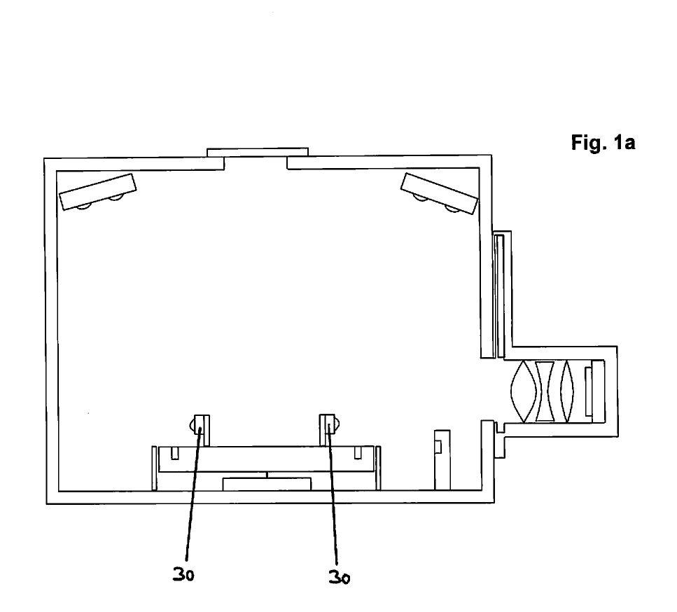

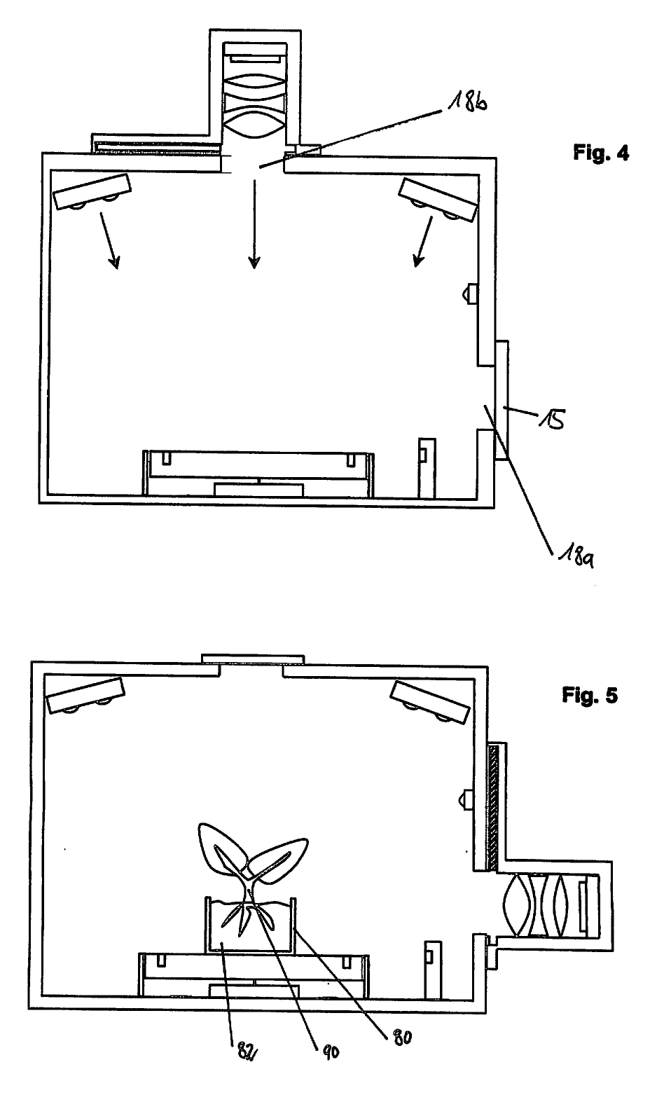

FIG. 3 shows an individual element of an irradiation device,

FIG. 4 shows the measuring device of FIG. 1 in a second state of operation,

FIG. 4a shows the measuring device of FIG. 1 with a second flanged-on camera,

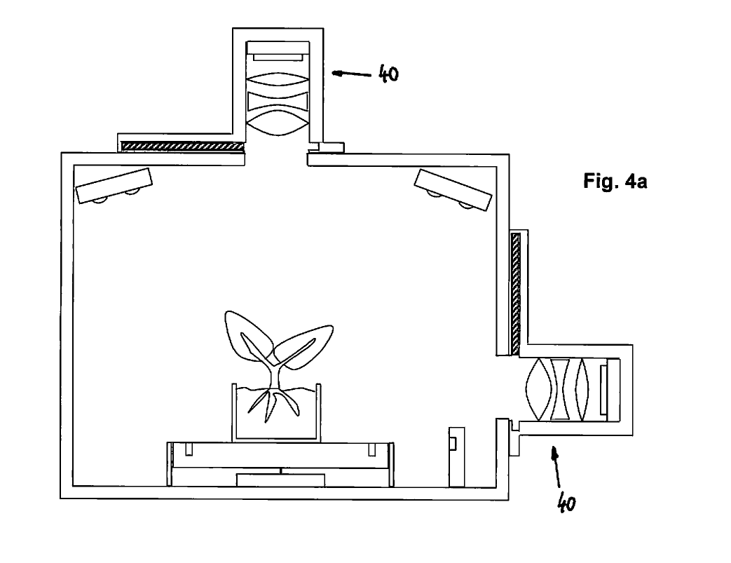

FIG. 5 shows the arrangement of FIG. 1 during a luminescence measurement on a single plant,

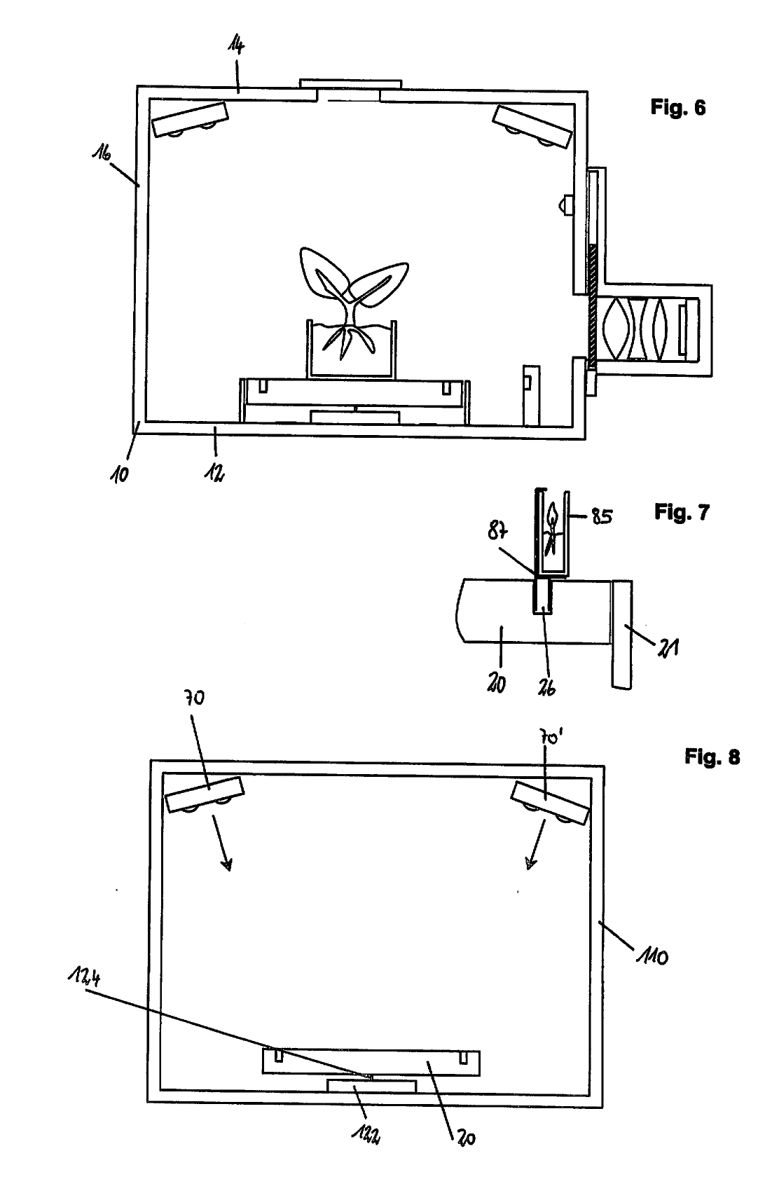

FIG. 6 shows the embodiment of FIG. 6 [sic] during the performance of a fluorescence measurement,

FIG. 7 shows the detail D of FIG. 1 with the presence of a plant cassette, and

FIG. 8 shows an irradiation device in an illustration corresponding to FIG. 1,

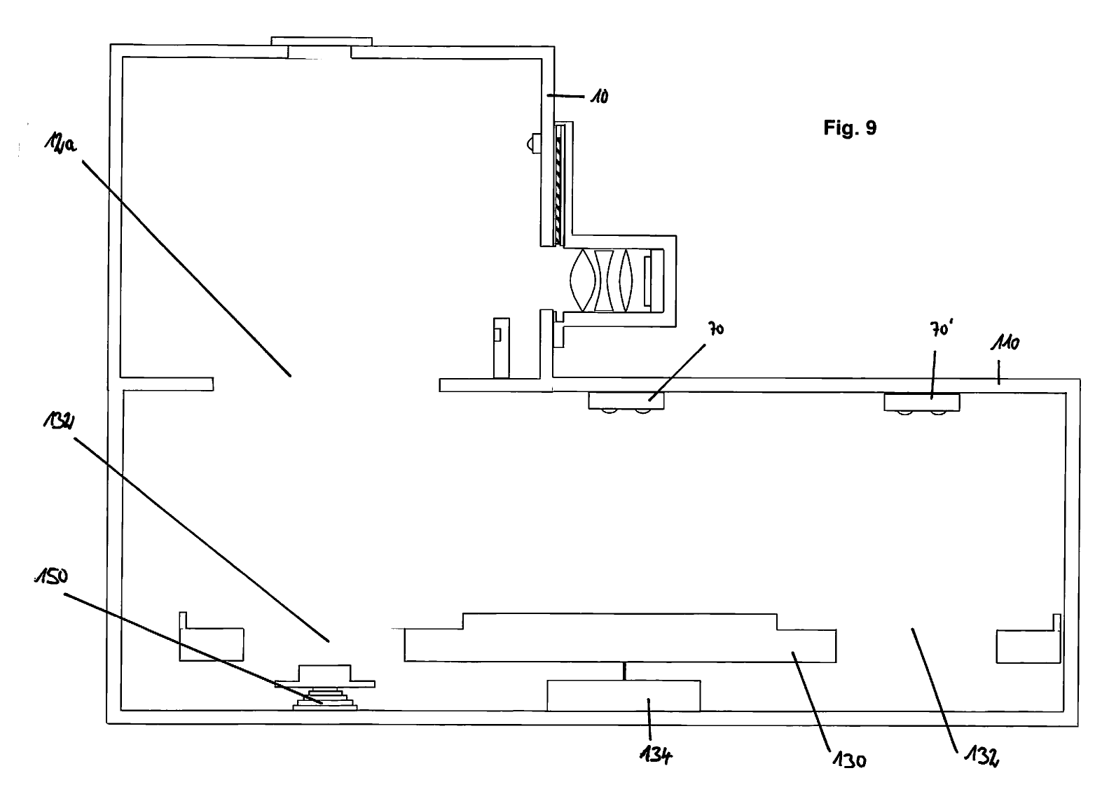

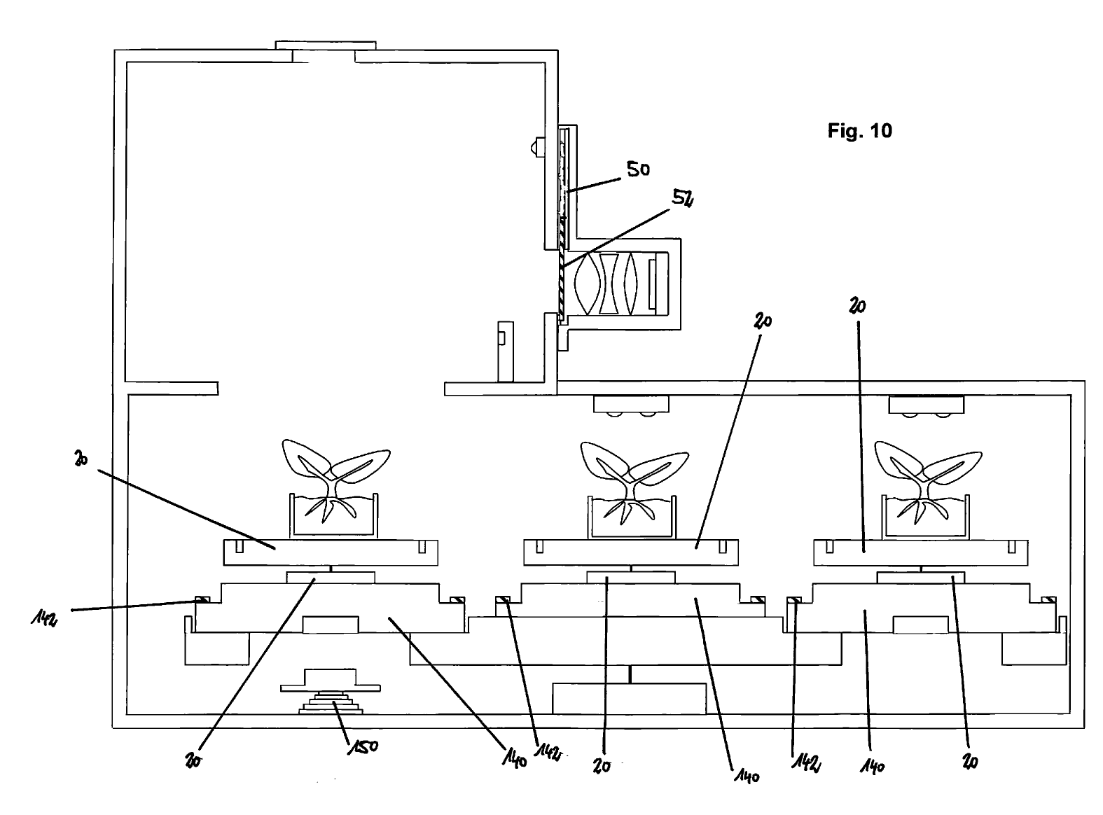

FIG. 9 shows an overall device in an illustration corresponding to FIG. 1, in an empty state,

FIG. 10 shows the embodiment of FIG. 9 in a first state of operation, and

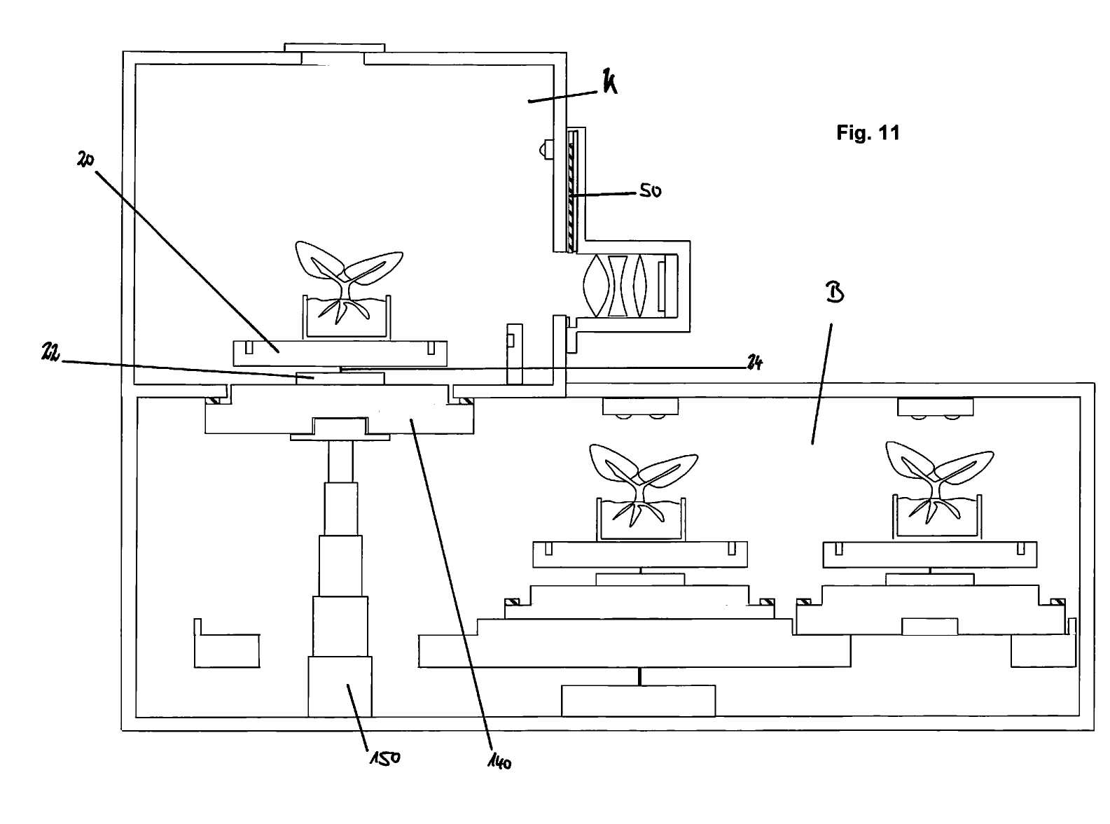

FIG. 11 shows the embodiment of FIG. 10 in a second state of operation.

FIGS. 1 and 2 show schematic sectional views of a measuring device, FIG. 2 being a section along the plane A-A of FIG. 1, and FIG. 1 being a section along the plane B-B of FIG. 2. In the following, reference will be made to both figures:

The measuring device comprises a housing 10 having a floor 12, a roof 14, and a side wall 16 having four sections. Provided in the front section of the side wall 16 is a door 17. With the door 17 closed, the housing 10 encloses in a light-tight manner a measuring chamber K. Arranged in a lower region of the housing 10 is a vertically arranged rotary shaft 24 that can be driven by means of a motor 22. On this rotary shaft, a rotary disk 20 can be arranged in a frictional connection as shown, which can thus be rotated by means of the rotary shaft. The rotary disk 20 consists, for example, of an aluminum plate, the surface of which is coated with a black lacquer in order to prevent reflections. The rotary disk 20 is surrounded by a static edge 21.

Provided in one section of the side wall 16 is a first measuring opening 18a, to which, in a first state of operation as it is shown in FIGS. 1 and 2, a camera 40 is flanged by means of suitable first fastening means, the connection between the camera and side wall 16 being light tight. The camera comprises a camera housing 44, a lens construction 42 having an entrance lens 42a, and a CCD sensor 46 that can be cooled by means of a cooler 48, which can be designed, for example, in the form of a Peltier cooler. A filter drawer is provided, by means of which an emission filter 50 can be placed in front of the entrance lens 42a. The optical path of the camera does not have any minors or prisms, such that the optical axis of the camera coincides with the line of vision B thereof. “Line of vision” B in this context shall be understood to mean the portion of the optical path that ends at the object to be observed. It is apparent that, in the first state of operation, the line of vision extends parallel to the floor 12 and rotary disk 20 in the horizontal direction H, that is to say perpendicular to the rotary shaft 24.

Arranged above the first measuring opening 18a is an irradiation means. The irradiation means comprises a plurality of individual elements. Because of the sectional view, in which only elements are shown that are situated in the sectional plane, two of these individual elements 70, 70′ can be seen. The irradiation means emits a spectrum that imitates the natural sunlight—or more specifically: the natural daylight. The design of the individual elements will be elaborated on in more detail below. The irradiation device S faces downward, but not necessarily exactly perpendicularly.

The depicted measuring device is intended also for the performance of fluorescence measurements, for which purpose a fluorescence excitation source 60 is provided that faces in the direction of the rotary disk 20. The exit window of this fluorescence excitation source 60 forms an excitation filter 64. When a fluorescence measurement is performed, the emission filter 50 is moved into the position shown in FIG. 6.

In the roof 14 of the housing, a second measuring opening 18b is provided which, in the first state of operation as it is shown in FIG. 1, is sealed in a light-tight manner by a blind flange 15.

Holding slots 26 that serve as a holding device extend into the rotary disk 20 from the upper side of the rotary disk. Additional holding devices are provided in the rotary disk 20 in the form of holding bores 28. Additionally, infrared LEDs 30 which can serve for photographic exposures are arranged directly behind the plant containers (see FIG. 1a) or—as shown in FIG. 1—at the wall in which the first measuring opening 18a is located. When, as depicted in FIG. 1a, the infrared LEDs 30 are arranged behind the plant containers, the power supply thereof is preferably provided by means of batteries/rechargeable batteries and control thereof is preferably wireless, for example, by radio control. The LEDs can be mounted also below the rotary disk, in which case a slot underneath the holding devices lets the light through upward and a diffuser behind the vertically arranged plant containers casts light onto the plants from behind (not depicted).

Because of the existence of holding devices on the rotary disk, plants can be arranged on this rotary disk in various ways. For example, it is possible to simply place a pot or a cup 80 in which a plant 90 is growing, centrally on the rotary disk, like it is shown in FIG. 5. In many cases it will be preferred in this context to select a pot or a cup 80 made of a transparent material which is filled with a transparent gel 82 in which the plant is growing.

Holders 87 for plant cassettes 85 can be inserted into the holding slots 26; the holding bores are suitable in particular for receiving so-called de-Wit plant chambers. FIG. 7 shows, in a detail view, a plant cassette 85 that is held on the rotary disk 20 by means of a holder 87 inserted into a holding slot 26. The plant chamber consists of a transparent plastic material.

FIG. 3 shows a schematic top view of an individual element 70 of the irradiation device, like it is installed in the measuring device. This individual element comprises a flat base plate 72 with a reflective surface and a plurality of LEDs arranged on the base plate—in the depicted illustrative embodiment four LEDs 74a-74d. Three of the LEDs are colored and have differing emission maxima, preferably 450 nm, 660 nm and 730 nm. The fourth LED has a white spectrum. As a result of this, the spectrum of the sunlight arriving on the earth's surface, that is to say the daylight, can be sufficiently accurately reproduced. In order to be able to simulate the daylight, both at different times of the day and at different latitudes of the earth, the LEDs can be controlled individually by means of a control unit. If, for example, the sunlight at noontime or near the equator is to be reproduced, it must be contain an increased proportion of blue. The fact that the LEDs can be controlled individually also makes it possible, in particular, to recreate the changing sunlight spectrum over the course of the day. Depending on the given application, LEDs with other emission maxima, for example around 500 nm (green) or around 580 nm (yellow) can be provided. In order to attain an ideal irradiation it can be useful to provide one individual element per each holding device for a plant cassette. In some applications it is also possible to exclusively use LEDs that emit a white spectrum. The individual elements that have just been described and the manner of controlling them can also be used for other applications in which daylight simulation is required.

FIG. 4 shows a second state of operation. Here, the camera is flanged by means of suitable second fastening means to the second measuring opening 18b and looks into the measuring chamber from above. In this case the first measuring opening 18a is sealed light-tight by means of a blind flange 15. Therefore the measuring device can also be used for “traditional” measuring geometries. Additionally, it is possible to flange two cameras to the chamber in order to thus be able to measure simultaneously or quasi-simultaneously from two lines of vision (FIG. 4a). These cameras may be of the same type or they may be designed differently.

The stand-alone operation of the measuring device takes place as described below:

### a) Combined Luminescence and Optical Measurement

A rotary disk 20 is placed onto the rotary shaft 24. On this rotary plate 20 the plant or plants to be observed are arranged and the door is closed. Then the measurement begins, which, as a rule, extends over several days, that is to say over several simulated day phases and night phases. All or a portion of the individual elements 70, 70′ of the irradiation device are switched on for a certain length of time, for example for 12 hours, in order to simulate daylight, with the frequency spectrum possibly varying over the course of same During the remaining hours of the day the irradiation elements 70, 70′ remain switched off. The irradiation elements 70, 70′ also serve as lighting for taking photographic exposures (if such are needed), for which purpose the camera 40 in a first state of operation takes optical exposures in certain time intervals. The luminescence measurements are carried out with the irradiation elements 70, 70′ switched off. During this process the camera is then in a second, highly sensitive state of operation. As a rule, it is necessary for the irradiation elements to be switched off a few minutes prior to carrying out the luminescence measurements, until an afterglow/a phosphorescence of the plants, of components of the measuring device and of the plant containers used has faded away. The images of the photographic exposures and of the luminescence measurements can be superimposed over one another in a subsequent data processing step. Between the individual photographic exposures or luminescence measurements, respectively, the rotary plate 20 can be rotated by a predetermined amount, such that a different view of the same plant or a different plant cassette or de-Wit chamber is located in front of the camera.

If photographic measurements are to be performed also during the “night phases”, the infrared LEDs 30 are switched on for this purpose. The emission wavelength in this case is preferably between 900 and 950 nm. Plants are insensitive in this range, and the “night simulation” therefore is not disrupted. A CCD sensor 46 that is sensitive in this wavelength range is inserted into the camera 40, such that the camera 40 can also be used to take photographic exposures during the night phases. Alternatively, it is also possible to use a separate IR camera. The luminescence exposures to be superimposed can, of course, also be taken during the night phases, such that superimposed images can accordingly be generated over the entire 24-hour cycle of the plants.

### b) Combined Fluorescence and Optical Measurement

In the fluorescence operation the emission filter 50 is moved in front of the entrance lens 42a (FIG. 6). The fluorescence measurement likewise takes place with the irradiation elements 70, 70′ switched off, but with the fluorescence excitation source 60 switched on. In other respects, the same applies here that has been said above in the context of the luminescence measurements.

As already mentioned above, a measuring cycle on plants stretches over the course of several days. The required net measuring time for the measurement of bioluminescence, chemoluminescence or fluorescence, as a rule, however, amounts only a few minutes a day. During the remainder of the time, the camera “sits idle”. Since the highly sensitive camera is an expensive component, however, this is relatively uneconomical. In the preferred embodiment described, the rotary plate therefore is not arranged rigidly on the rotary shaft but can be removed from same. Therefore a rotary plate can be placed into the measuring chamber only for measuring and be arranged during the remaining time in an irradiation device. Such an irradiation device is shown in a schematic sectional view in FIG. 8. This irradiation device preferably also has a light-tight housing. Arranged inside this light-tight housing is an irradiation device like it has been described above. In order to ensure an even irradiation, a rotary shaft can be provided that can likewise be driven by a motor, however this is not imperative. It is also possible to provide a static holding device.

A measuring system can have a plurality of such irradiation devices per measuring device, the rotary plates being moved into the measuring device always only for measuring purposes and remaining in the irradiation devices during the remainder of the time. The number of plants that can be observed by means of only one highly sensitive camera during a time interval can thus be significantly increased. In order to be able to uniquely identify each individual measurement, the rotary plates or the individual plant cassettes/de-Witt chambers can each be equipped with a RFID chip, and a RFID reader 95 is arranged in this case in the measuring chamber. Other identification systems can be used in lieu of a RFID system, for example such that operate with barcodes.

The method that has just been described can also be automated to a significant degree, in which case feeding of the rotary plates 20 into the measuring chamber K takes place by means of a mechanical feeder system. Such a mechanical feeder system can be a so-called stacker or a robot. In order to be able to utilize such a stacker or robot, a light-tight feed-through opening is installed in lieu of the door, like in a plate luminometer. This light-tight feed-through opening can have mechanical feeder systems of any kind connected thereto.

Additionally, the option exists to integrate the measuring device, irradiation device and mechanical feeder system into an overall device. One example of such an overall device is shown in FIGS. 9 to 11. Here, the housing 110 of the irradiation device is arranged directly under the housing 10 of the measuring device and both housings are preferably connected directly to one another. In the depicted illustrative embodiment, the floor 12 of the housing of the measuring device coincides with a portion of the roof of the housing 110 of the irradiation device. The floor 12 of the housing 10 of the measuring device has an opening 12a. Situated below this opening is a lifting device 150 serving as a mechanical feeder system.

Located within the housing 110 of the irradiation device is a mechanical traversing system, by means of which the rotary plates 20 can be moved into a position below the opening 12a and away from same. In the depicted illustrated example this mechanical traversing system comprises a conveying rotary plate 130 that can be driven by means of a motor 134. This conveying rotary plate 130 has a plurality of stepped apertures 132 that are equidistant to the perpendicularly extending rotary shaft of the motor 134. The dimensions have been selected such that each stepped aperture 132 can be positioned over the lifting device 150.

Each rotary plate 20 is arranged on a base plate 140 that also carries the motor 22 for the rotary plate. Each base plate 140 carries an annular light seal. Such a light seal 142, which, as a rule, is an opaque, elastic element, can alternatively or additionally also be arranged on the underside of the floor 12. The diameter of the base plates 140 is larger than the diameter of the rotary plate 20, larger than the smallest diameter of the stepped apertures 132, and smaller than the largest diameter of the stepped apertures 132.

When the plant/plants on a rotary plate 20 is/are to be measured, the conveying rotary plate 130 is rotated into the position in which the corresponding rotary plate 20 is located over the lifting device 150 (FIG. 10). The lifting device 150 is now operated by means of a control unit (not shown) and the rotary plate 20 is lifted until the base plate 140 thereof, or the light seal 142 of the base plate, makes contact from below with the floor 12 of the housing 10 (FIG. 11). In this position the rotary shaft 24 and the rotary plate 20 are located within the measuring chamber K and the base plate 140 seals the chamber K in a light-tight manner. The motor 22 is actuated and the desired measurement is carried out as described above. Power to the motor 22 can be supplied via contacts on the base plate and on the underside of the floor 12 (not shown). After completion of the measurement, the rotary plate 20 moves back into the interior of the irradiation device, that is to say into the irradiation chamber B, via lowering of the lifting device 150. Here, too, using a RFID system or other identification system is useful, as a rule. Additionally, it can be useful to provide a mechanical shutter 52 that closes the camera 40 when in the non-measuring state. The described overall device can operate fully automatically.

### LIST OF REFERENCE SYMBOLS

10 housing
12 floor
12a opening in the floor
14 roof
15 blind flange
16 side wall
17 door
18a first measuring opening
18b second measuring opening
20 rotary plate
21 edge
22 motor
24 rotary shaft
26 holding slots
28 holding bores
30 infrared LED
40 camera
42 lens construction
42a entrance lens
44 housing
46 CCD sensor
48 cooler
50 emission filter
52 shutter
60 fluorescence excitation source
62 LED
64 excitation filter
70 individual element
72 base plate
74 LED
80 cup
82 gel
85 plant cassette
87 holder
90 plant
95 RFID reader
110 housing of the irradiation device
122 motor of the irradiation device
124 rotary shaft of the irradiation device
130 conveying rotary plate
132 stepped aperture
134 motor of the conveying rotary plate
140 base plate
142 light seal
150 lifting device
K measuring chamber
B irradiation chamber

1. A measuring device for the measurement of bioluminescence, chemoluminescence or fluorescence of objects, comprising a light-tight housing (10) enclosing a measuring chamber (K) and a highly sensitive camera (40) looking into the measuring chamber, characterized in that there is arranged in the measuring chamber (K) a vertically extending rotary shaft (24) for the arrangement of a rotary disk (20), and that in a first state of operation the line of vision of the camera (40) is substantially horizontal.

2. A measuring device as claimed in claim 1, wherein the rotary shaft (24) has a rotary disk (20) arranged thereon.

3. A measuring device as claimed in claim 2, wherein the rotary disk (20) has holding devices for a plurality of vertically arranged plant cassettes.

4. A measuring device as claimed in claim 1, characterized in that at least one irradiation means is provided that can radiate from above in the direction of the rotary disk position.

5. A measuring device as claimed in claim 4, wherein the irradiation means has a plurality of individual elements (70, 70′), each of which carry at least 3 LEDs (74).

6. A measuring device as claimed in claim 4, wherein the LEDs (74) of an individual element are arranged on a plate (72) in one plane.

7. A measuring device as claimed in claim 5, wherein each individual element is assigned to exactly one plant cassette.

8. A measuring device as claimed in claim 1, wherein in a second state of operation the line of vision of the camera (40) is substantially perpendicular.

9. A measuring device as claimed in claim 8, wherein the housing has two spaced-apart fastening means for the camera, the first state of operation existing when the camera is fastened to the first fastening means, and the second state of operation existing when the camera is fastened to the second fastening means.

10. A measuring device as claimed in claim 1, wherein there is provided a fluorescence light source.

11. An irradiation device for plant cassettes that are arranged on a rotary disk, having a holding device for a rotary disk and an irradiation means that can radiate from above in the direction of the rotary disk position.

12. An irradiation device as claimed in claim 11, wherein the irradiation means has a plurality of individual elements (70), each of which carries at least 3 LEDs.

13. An irradiation device as claimed in claim 12, wherein the LEDs of an individual element are arranged on a plate in one plane, said plane being substantially perpendicular.

14. An irradiation device as claimed in claim 12, wherein each of the plant cassettes that can be arranged on the rotary disk has exactly one individual element assigned thereto.

15. A measuring system comprising a measuring device as claimed in claim 1, at least one irradiation device for plant cassettes that are arranged on a rotary disk, having a holding device for a rotary disk and an irradiation means that can radiate from above in the direction of the rotary disk position, in and at least one rotary disk.

16. A measuring system as claimed in claim 15, wherein at least two irradiation devices and at least two rotary disks are provided.

17. A measuring system as claimed in claim 15, wherein the measuring device and irradiation device are situated adjacent to one another and a mechanical feeder system is provided for automatic transport of rotary disks between the measuring device and the irradiation device.

18. A measuring system as claimed in claim 17, wherein the irradiation device is arranged below the measuring device and that the mechanical feeder system comprises a lifting device.

19. A method for the observation of plants using a measuring system as claimed in claim 15, the at least one rotary disk being transported back and forth repeatedly between the irradiation device and the measuring device.
